(19) United States
(12) Patent Application Publication
(10) Pub. No.: US 2008/0287637 A1
(43) Pub. Date: Nov. 20, 2008

(54) Method for Improving the Surface Smoothness of Planar Textile Structures

(75) Inventors: Markus Schuetz, Stuttgart (DE); Florian Felix, Garmisch-Partenkirchen (DE); Holger Bender, Ditzingen (DE)

Correspondence Address: PERMAN & GREEN, 425 POST ROAD, FAIRFIELD, CT, 06824, US

(73) Assignee: HOLMENKOL SPORT-TECHNOLOGIES GMGH & CO. KG, Ditzingen (DE)

(21) Appl. No.: 11/908,144

(22) PCT Filed: Mar. 10, 2006
(86) PCT No.: PCT/EP2006/002227

§ 371 Date: Jun. 3, 2008

(30) Foreign Application Priority Data
Mar. 10, 2005 (DE) 10 2005 011 112.2

(51) Int. Cl. C08G 77/26

(52) U.S. Cl. 528/38

(57) ABSTRACT

A method for improving the surface smoothness of planar textile structures, in particular sails, sunblinds, or textiles used in vehicles by applying at least one aminopolysiloxane. In this way it becomes possible to achieve individual and, in particular, new combinations of properties and effects, such as better aerodynamic properties, reduced air permeability, good soil repellence, increased elasticity, good water repellence, reduction of frictional forces during use.

### CROSS-REFERENCE TO RELATED APPLICATION

This application is the National Stage of International Application No. PCT/EP2006/002227, International Filing Date, 10 Mar. 2006, which designated the United States of America, and which international application was published under PCT Article 21(2) as WO Publication No. WO 2006/094820 A1 and which claims priority from German Application No. 10 2005 011 112.2, filed 10 Mar. 2005.

### BACKGROUND

1. Field

The disclosed embodiments relate to a method for improving the surface smoothness of planar textile structures by applying special aminopolysiloxanes onto the planar textile structures, and to the appropriate smoothing agents comprising these particular aminopolysiloxanes.

2. Brief Description of Related Developments

Aminopolysiloxanes and methods for producing the same have been known in the prior art. In printed publication WO 2004/046452, e.g., a plurality of aminopolysiloxanes are described which are provided for the most various applications; they are to serve, above all, as emollients in washing powders. In printed publication EP 95238 compositions for conditioning hair are described which contain aminopolysiloxanes. According to U.S. Pat. No. 4 247 592 aminofunctional silicones are used for improving the water repellence of synthetic fibres.

The disclosed embodiments relate to the use of the below described aminopolysiloxanes for improving the surface smoothness of planar textile structures in particular for improving the surface smoothness at a microscopic scale. By applying these aminopolysiloxanes onto planar textile structures, due to the changed surface smoothness, individual and, in particular, combinations of the subsequently mentioned properties and effects can be obtained: better aerodynamic properties, in particular an optimal laminar air flow at planar textile structures such as sails (e.g. for sailing boats, surfboards, and the like) or paragliders—turbulences occurring at the planar structures being assumed to be reduced—, a reduced air permeability, a better visual impression of the surface (e.g. brilliance, colour rendering), resistance to soiling, increased elasticity, abrasion protection, buckling stability, reduction of frictional forces during handling, protection of the textiles against light, chemicals, temperature and weather conditions, in particular sea water, reduced generation of mildew and better resistance to tearing and continued tearing of the textile structure.

Thus, in more detail, the disclosed embodiments relate to a method for improving the surface smoothness of planar textile structures, in particular for the improvement of the surface smoothness at a microscopic scale, which resides in applying at least one linear or branched polysiloxane onto the textile structures, which is constituted of the units SiO_{4/2}, R′SiO_{3/2}, R′₂SiO_{2/2} and R′₃SiO_{1/2}, the groups R′, which are identical or different, being organic residues, provided that at least one group R′ comprises at least one nitrogen atom.

### SUMMARY

According to a preferred embodiment the aminopolysiloxanes of the following formula I are used as means for improving the surface smoothness:

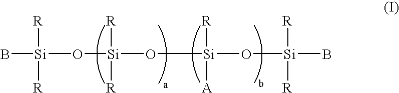

wherein:
the groups R being identical or different from each other represent a monovalent hydrocarbon group having 1 to 10 carbon atoms, e.g. an alkyl group, an aryl group or an aralkyl group having 1 to 10 carbon atoms, such as methyl, ethyl or phenyl, and in particular a monovalent hydrocarbon group having 1 to 4 carbon atoms, in particular methyl;
the groups B being identical or different represent a group R, a group A, a hydrogen atom, a hydroxy group, or an alkoxy group having 1 to 4 carbon atoms;
the group A represents a group of the following formula II:

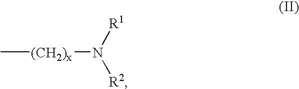

wherein, in formula II, x represents an integer of 1 to 8 and, preferably, within the range of 2 to 4, and the groups R¹ and R² being identical or different are selected among a hydrogen atom, an alkyl group having 1 to 8 carbon atoms and, preferably, 1 to 4 carbon atoms, an hydroxyalkyl group having 2 to 4 carbon atoms or an alkyleneamino group —(CH₂)_{y}—NR³R⁴, wherein y is an integer from 2 to 8 and, preferably, 2 to 4, and the groups R³ and R⁴ being identical or different represent a hydrogen atom, an alkyl group having 1 to 8 carbon atoms and, preferably, 1 to 4 carbon atoms, or an hydroxyalkyl group having 2 to 4 carbon atoms;
a and b represent integers which are selected so that the sum (a+b) lies in the range of 1 to 3000 and, in particular, in the range of 200 to 1000.

The ratio of nitrogen-free polysiloxane units to nitrogen-containing polysiloxane units in the aminopolysiloxanes used according to the disclosed embodiments is preferably 1:1 to 500:1.

The typical nitrogen content of the aminopolysiloxanes used according to the disclosed embodiments lies, e.g., in the range of 0.005 to 18% by weight, preferably in the range of 0.02 to 5% by weight, and especially preferably in the range of 0.02 to 1% by weight.

The groups of alkyl, alkylene, hydroxyalkyl or alkoxy of formula I or II can be linear as well as branched groups.

The nitrogen-free groups R′ and the groups R of formula I preferably represent a monovalent hydrocarbon group having 1 to 4 carbon atoms, in particular the methyl group.

The nitrogen-containing groups R′ and the groups A of formula I can further possibly be hydroxylated.

As particularly preferred nitrogen-containing groups R′ and groups A, respectively, e.g., the following groups can be mentioned: C₃H₆NH₂, C₃H₆N(CH₃)₂, C₃H₆N(CH₂CH₃)₂, C₃H₆N(CH₂CH₂OH)₂, C₃H₆NH(CH₂CH₂NH₂) or C₃H₆N(CH₃)(CH₂CH₂NH₂).

Aminopolysiloxanes which are particularly preferably used according to the disclosed embodiments are compounds of formula I which meet one and, preferably, all of the following conditions: R represents methyl or phenyl, B represents methyl or phenyl, A represents aminopropyl or aminoethylaminopropyl.

Especially preferably a poly(aminoalkylmethyl/dimethyl)siloxane and, in particular, a poly(aminoethylaminopropylmethyl/dimethyl)-siloxane are used.

The aminopolysiloxanes used according to the disclosed embodiments can be block polymers as well as alternating polymers.

The aminopolysiloxanes can, possibly, also be quaternated.

The disclosed embodiments further relate to surface smoothing agents which comprise the above defined aminopolysiloxanes or consist thereof. The surface smoothing agents can be present in the form of aqueous, alcoholic or aqueous-alcoholic solutions, as dispersions or as emulsions. A particularly interesting embodiment resides in employing them in the form of emulsions and, in particular, in the form of silicon-in-water-emulsions.

The concentration of the above defined aminopolysiloxanes in the surface smoothing agent preferably lies in the range of 20 to 40% by weight and, in particular in the range of 30 to 40% by weight.

Furthermore, it is possible to dilute the surface smoothing agent with water before the application, e.g., a dilution of surface smoothing agent/water of 1:10 coming into question.

The surface smoothing agents according to the disclosed embodiments can also comprise additives which are common for compositions and, in particular, emulsions to be applied to planar textile structures, such as solvents, thickeners, surface-active sub-stances for improving the emulsifiability, preferably cationic or non-ionic surface-active substances, and the like.

According to the disclosed embodiments planar textile structures are, in accordance with the general definition, planar structures which are made of textile fibres, which can equally be selected among natural fibres such as cotton, hemp or silk, synthetic fibres such as polyamide fibres (e.g. aramide fibres, Nylon® fibres), polyester fibres (e.g. Dacron®, Mylar®), polyethylene fibres or polypropylene fibres, or inorganic fibres such as glass fibres or carbon fibres.

Because of the various favourable combinations of properties which can be attained by the improvement of the surface smoothness by applying the aminopolysiloxanes, the method according to the disclosed embodiments is applied, particularly preferably, e.g., in the case of sails such as spinnaker sails, paragliders or parachutes, kite chutes, convertible hoods, or sunblinds.

Due to the improved surface smoothness the aerodynamics, and thus the slidability of sails (boats, surfboards, etc.) can be considerably improved and the air permeability can be reduced, what, of course, has a very positive effect on the speed which can be reached in each case. Furthermore, the lifetime of the sails can be prolonged, since the surface is better protected against environmental attacks (sea water, light, chemicals, mildew, and the like). A further advantage is a quicker drying of the sails because of the improved water repellence.

In the case of textiles which are used in motor vehicles, e.g. convertible hoods, and in the same way also for sunblinds, a very good soil repellence and photostability of the treated textiles is obtained due to the surface smoothness improvement according to the disclosed embodiments. In this case also the reduction of the frictional forces is advantageous when folding the hood or when rolling-up the sunblind.

The surface smoothing agents according to the disclosed embodiments can be tailored in the most various forms, e.g. in an aerosol container by using a propellant, or in a pumping bottle; it is also possible to apply the aminopolysiloxane(s) directly, or, if they do not have the suitable viscosity, particularly in the form of solutions, dispersions or emulsions with any suitable agents, onto the planar textile structure or to immerse the planar textile structure therein.

The aminopolysiloxanes used according to the disclosed embodiments can be produced according to methods which have been known in the prior art for the production of aminated polysiloxanes and which were described, e.g., in the patent U.S. Pat. No. 5,593,611.

In the following, examples are indicated for explaining the disclosed embodiments.

### EXAMPLE 1

From poly-co-(aminoalkylmethyl-dimethyl)siloxane a cationic emulsion of approximately 35% in water is produced. The viscosity lies at about 300 mPa·s and the amine content in the polymer of the emulsion is 0.3 mmol/g. Before the application, the emulsion is diluted with water in a ratio of 1:10 and set to a pH value of about 5 by adding acetic acid. The described emulsion is applied onto a 2 years old used paraglider chute (cloth: Nylon, manufacturer: Swing) by means of a sponge. Excess material is removed by a sponge. When the emulsion has dried, a thin film has formed on the fabric.

According to experts' opinions the textile fabric, due to the coating, has become much smoother and more air-impermeable by the factor 2 to 4. All this has positive effects on the flight properties of the paraglider. Appearance and colour approximately correspond again to the new condition. Due to the smoothing of the fabric, the handling, e.g. during starting, is considerably improved. The paraglider chute is less likely to be caught by stones or branches and is, therefore, protected against damages. Moreover, after landing, it can more easily be repacked. Due to the repelling properties of the coating the chute is additionally protected against dirt and water absorption, what results in an increased safety during the flight. Moreover, the paraglider chute can be cleaned more easily

### EXAMPLE 2

From poly-co-(aminoalkylmethyl-dimethyl)siloxane a cationic emulsion of approximately 35% in water is produced. The viscosity lies at about 300 mPa·s and the amine content in the polymer of the emulsion is 0.3 mmol/g. Before the application, the emulsion is diluted with water in a ratio of 1:10 and set to a pH value of about 5 by adding acetic acid. The described emulsion is applied onto a commercial spinnaker sail made of Nylon by means of a sponge. Excess material is removed by a sponge. When the emulsion has dried, a thin film has formed on the fabric.

According to experts' opinions the textile fabric, due to the coating, has become much smoother and more air-impermeable by the factor 2 to 4. All this has positive effects on the aerodynamic properties of the sail, what makes the boat faster. Appearance and colour approximately correspond again to the new condition. Due to the smoothing of the fabric, the handling, e.g. when hoisting and recovering the spinnaker, is considerably improved. It slides more easily over the side of the boat, can more easily be packed and is, therefore, protected against damages. Due to the repelling properties of the coating the sail is additionally protected against dirt and water absorption and can be cleaned more easily.

### EXAMPLE 3

From poly-co-(aminoalkylmethyl-dimethyl)siloxane a cationic emulsion of approximately 35% in water is produced. The viscosity lies at about 300 mPa·s and the amine content in the polymer of the emulsion is 0.3 mmol/g. Before the application, the emulsion is diluted with water in a ratio of 1:10 and set to a pH value of about 5 by adding acetic acid. The described emulsion is applied onto a commercial convertible hood (black textile hood, Honda S 2000) by means of a sponge. Excess material is removed by a sponge. When the emulsion has dried, a thin film has formed on the fabric.

According to experts' opinions the hood, due to the coating, has become much smoother. Appearance and colour approximately correspond again to the new condition. The repelling properties of the coating cause dirt and water to roll off, so that the hood has to be cleaned considerably less often. The dirt adhering thereto after a quite a long time can easily be wiped off with a wet sponge.

1. Method for improving the surface smoothness of planar textile structures,
characterized in that
at least one aminopolysiloxane is applied onto the planar textile structure, which is constituted of units SiO_{4/2}, R′SiO_{3/2}, R′₂SiO_{2/2} and R′₃SiO_{1/2}, the groups R′, which are identical or different, being organic residues, provided that at least one group R′ comprises at least one nitrogen atom.

2. Method according to claim 1, characterized in that the aminopolysiloxanes are selected among the compounds of the following formula I 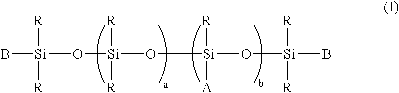
wherein:
the groups R being identical or different from each other represent a monovalent hydrocarbon group having 1 to 10 carbon atoms, e.g. an alkyl group, an aryl group or an aralkyl group having 1 to 10 carbon atoms, in particular methyl,
the groups B being identical or different represent a group R, a group A, a hydrogen atom, a hydroxy group, or an alkoxy group having 1 to 4 carbon atoms;
the group A represents a group of the following formula II: 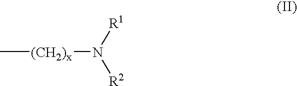
wherein, in formula II, x represents an integer of 1 to 8 and, preferably, within the range of 2 to 4, and the groups R¹ and R² being identical or different are selected among a hydrogen atom, an alkyl group having 1 to 8 carbon atoms and, preferably, 1 to 4 carbon atoms, an hydroxyalkyl group having 2 to 4 carbon atoms or an alkyleneamino group —(CH₂)_{y}—NR³R⁴, wherein y is an integer from 2 to 8 and, preferably, 2 to 4, and the groups R³ and R⁴ being identical or different represent a hydrogen atom, an alkyl group having 1 to 8 carbon atoms and, preferably, 1 to 4 carbon atoms, or a hydroxyalkyl group having 2 to 4 carbon atoms, wherein group A can possibly also be hydroxylated;
a and b represent integers which are selected so that the sum (a+b) lies in the range of 1 to 3000 and, in particular, in the range of 200 to 1000.

3. Method according to claim 1, characterized in that the nitrogen-containing group R′ or the group A is selected among the following groups:
C₃H₆NH₂, C₃H₆N(CH₃)₂, C₃H₆N(CH₂CH₃)₂, C₃H₆N(CH₂CH₂OH)₂, C₃H₆NH(CH₂CH₂NH₂) or C₃H₆N(CH₃)(CH₂CH₂NH₂).

4. Method according to claim 3, characterized in that the compounds of formula I meet at least one and, preferably, all of the following conditions:
R represents methyl or phenyl, B represents methyl or phenyl, A represents aminopropyl or aminoethylaminopropyl.

5. Method according to claim 1, characterized in that in the used aminopolysiloxanes the ratio of the nitrogen-free polysiloxane units to the nitrogen-containing polysiloxane units lies within the range of 1:1 to 500:1.

6. Method according to claim 1, characterized in that the nitrogen content of the aminopolysiloxanes defined in the preceding claims lies within the range of 0.005 to 18% by weight, in particular of 0.02 to 5% by weight and especially of 0.2 to 1% by weight, relative to the total weight of the aminopolysiloxane.

7. Method according to claim 1, characterized in that the planar textile structure is made of textile fibres which are selected among natural fibres, synthetic fibres and/or inorganic fibres.

8. Method according to claim 1, characterized in that the aminopolysiloxanes are applied as such or in the form of an aqueous, an aqueous-alcoholic or an alcoholic solution, dispersion or emulsion and, in particular, as a silicon-in-water emulsion.

9. Surface smoothing agent for planar textile structures,
characterized in that it comprises at least one aminopolysiloxane as defined in claim 1.
